(19) United States
(12) Patent Application Publication
(10) Pub. No.: US 2010/0175473 A1
(43) Pub. Date: Jul. 15, 2010

(54) SENSOR SYSTEM

(76) Inventor: Johannes CLASSEN, Reutlingen (DE)

Correspondence Address: KENYON & KENYON LLP, ONE BROADWAY, NEW YORK, NY, 10004, US

(21) Appl. No.: 12/614,176

(22) Filed: Nov. 6, 2009

(30) Foreign Application Priority Data
Jan. 13, 2009 (DE) 102009000167.0

(51) Int. Cl. G01P 15/10

(52) U.S. Cl. 73/514.29

(57) ABSTRACT

A sensor system having a substrate, that has a main plane of extension, and a seismic mass, the seismic mass being developed movably about a torsional axis that is parallel to the main plane of extension; and the seismic mass having an asymmetrical mass distribution with respect to the torsional axis; and furthermore an area of the seismic mass facing the substrate is developed symmetrically with respect to the torsional axis.

### CROSS-REFERENCE

This application claims the benefit under 35 U.S.C. §119 of German Patent Application No. DE 102009000167.0 filed on Jan. 13, 2009, which is expressly incorporated herein by reference in its entirety.

### FIELD OF THE INVENTION

The present invention relates to a sensor system.

### BACKGROUND INFORMATION

A sensor system is described, for instance, in European Patent No. EP 0 244 581 A1, which has a silicon chip on which, using etching technology, two equal pendulums having asymmetrically developed rotating masses, and the masses of the pendulums each being fastened to a torsion rod.

A micromechanical acceleration sensor is also described in European Patent No. EP 0 773 443 A1, at least one first electrode being provided on a first semiconductor wafer to form a variable capacitance and a movable electrode in the form of an asymmetrically suspended rocker being provided on the second semiconductor wafer. Because of the asymmetrical suspension, the rocker experiences a torque about an axis of rotation of the first electrode, in response to an acceleration of the micromechanical acceleration sensor perpendicular to the wafer surface of the first semiconductor wafer, a deflection of the rocker as a result of this torque being detectable by a variation in the electrical capacitance between the first and the second electrode. Thus, the variation in the capacitance is a measure of an acting acceleration.

This acceleration sensor has the disadvantage that, based on the asymmetrical mass distribution of the first electrode, the lower side of the first electrode has no symmetrical geometry with respect to the axis of rotation, compared to the upper side of the substrate. The result is that, when potential differences occur between the first electrode and the substrate, for instance, based on trapped surface charges at the silicon surfaces, an effective force action on the first electrode is produced, since, in this case, even the surface charges are not distributed symmetrically with respect to the axis of rotation, based on the asymmetrical geometry of the first electrode. Especially in response to a variation of these surface potentials as a function of a temperature, or as a function of the service life of the sensor, the danger exists of rocker tipping as a result of the effective force actions, and consequently, undesired offset signals and a reduction in the measuring accuracy of the sensor.

An additional disadvantage of the acceleration sensor is that, in response to bending of the substrate based on an outer stress caused, for instance, by mechanical stresses of an outer housing or thermomechanical stresses in the substrate, which vary the distances between the first and the second electrode, whereby undesired offset signals and a reduction in the measuring accuracy of the sensor are also produced.

### SUMMARY

An example sensor system according to the present invention, may have the advantage that, on the one hand, the measuring accuracy is increased in a manner that is comparatively simple and cost-effective to implement, and on the other hand, the danger of undesired offset signals is reduced. In particular, the sensitivity of the example sensor system with respect to surface charges and/or with respect to mechanical stress is reduced. A reduction in the sensitivity of the sensor system with respect to surface charges is achieved in that the surface, facing the substrate, of the seismic mass is developed symmetrically with respect to the torsional axis, so that the force effects of potential differences between the side of the seismic mass facing the substrate and the substrate on both sides of the torsional axis generally compensate each other mutually. Consequently, the resulting force effect on the seismic mass is advantageously generally equal to zero, so that even in case of variation of the surface potentials as a function of the temperature and/or the service life, no undesired deflection of the seismic mass is produced. A reduction in the sensitivity of the sensor system with respect to mechanical stress is achieved in that the linking region is positioned perpendicular to the torsional axis and parallel to the main plane of extension in the vicinity of the suspension region and/or directly adjacent to the suspension region. The result is that, in response to a bending of the substrate, the geometry between the electrode and the seismic mass does not vary or varies only insubstantially, since both the electrode and the seismic mass are fastened on the substrate in a common region, and particularly in a comparatively small common region. The linking region and the expansion region are thereby bent in the same way at most, so that especially the relative distance between the electrode and the seismic mass does not vary or varies only insubstantially. The reduction in the sensitivity of the sensor system with respect to mechanical stress makes possible particularly advantageously a comparatively cost-effective packaging of the sensor system in mold packaging. In both cases, the sensitivity of the sensor system is advantageously reduced, the reduction in the sensitivity with respect to surface charges by the symmetrically developed lower side of the seismic mass being of great importance if the reduction of the sensor system with respect to mechanical stress is also implemented by the arrangement of the linking region in the suspension region. This results from the fact that the bending of the substrate with respect to the seismic mass leads to a variation in the distance between the substrate and the seismic mass perpendicular to the main plane of extension, so that, with respect to the torsional axis, asymmetrical, electrostatic interactions are able to be reinforced between the seismic mass and the substrate, as a result of surface charges, by a bending of the substrate. A reduction in the sensitivity to surface charges must therefore particularly advantageously follow a reduction in the sensitivity to stress. The equivalent also applies in reverse.

According to one preferred refinement, it is provided that the seismic mass has at least one mass element on the side facing away from the substrate, for producing the asymmetrical mass distribution, so that, in an advantageous manner, a mass distribution of the seismic mass that is asymmetrical with respect to the torsional axis is achieved, in spite of the fact that the side facing the substrate has a symmetrical geometry with respect to the torsional axis. The mass element is especially deposited on the side of the seismic mass facing away from the substrate in an epitaxial method.

According to another preferred refinement, it is provided that, on the side facing away from the substrate, a compensation element is also situated, the torsional axis being situated parallel to the main plane of extension, preferably between the mass element and the compensation element. The compensation element is provided especially advantageously for compensating for electrostatic interactions which are caused by the mass element. Parasitic electrical capacitances on the side of the mass element are particularly compensated for by the compensation element. In this context, the compensation element is especially developed to be lighter than the mass element, so that, because of the compensation element, no weight compensation on the other side of the torsional axis takes place for the mass element. The electrostatic interactions to be compensated for by the compensation element include, in particular, electrostatic interactions between the mass element and a stationary electrode, which is situated perpendicular to the main plane of extension, preferably below or above the seismic mass, and parallel to the main plane of extension, preferably next to the mass element, corresponding and equally great electrostatic interactions being produced on the other side of the torsional axis, between the compensation element and a stationary, additional electrode, which is preferably situated analogously to the stationary electrode. The sum of the electrostatic interactions is accordingly zero, or generally zero.

According to an additional preferred refinement, it is provided that the seismic mass has a first and a second interaction area, the first interaction area being associated with a stationary electrode and the second interaction area being associated with a stationary, additional electrode; and the size of the first interaction area being equal to the size of the second interaction area; and in particular, the geometric shape of the first interaction area being equal to the geometric shape of the second interaction area. Thus, compensation for the electrostatic interactions between the first interaction area and the electrode and the second interaction area and the additional electrode is achieved particularly advantageously. This has especially the advantage that, besides the electrostatic force effects, occurring on both sides of the torsional axis, on the side of the seismic mass facing the substrate, the electrostatic interactions occurring on both sides of the torsional axis, on the side of the seismic mass facing away from the substrate mutually compensate for each other. The sum of the effective forces that act upon the seismic mass because of surface charges is therefore advantageously zero or generally zero. A respective interaction area, within the meaning of the present invention, especially includes that surface of the seismic mass which cooperates electrostatically directly with the electrode or the additional electrode.

According to another preferred refinement, it is provided that the first and the second interaction areas are particularly developed symmetrically with respect to the torsional axis, the first interaction area particularly including areas of the side of the seismic mass facing away from the substrate and areas of the mass element, and the second interaction area including additional areas of the side of the seismic mass facing away from the substrate and areas of the compensation element. The first and the second interaction areas therefore preferably include areas of the seismic mass, of the mass element and/or of the compensation element, the areas being particularly preferably aligned both in parallel to the main plane of extension and also perpendicular to the main plane of extension. The electrostatic interaction between the electrode and the mass element on the one side of the torsional axis is thus particularly advantageously compensated by an interaction between the additional electrode and the compensation element on the other side of the torsional axis, without a weight compensation with respect to the torsional axis being produced in the process.

It is provided, according to another preferred refinement, that the distance between the suspension region and the linking region encompass, as seen perpendicular to the torsional axis and parallel to the main plane of extension, preferably less than 50 percent, especially preferred less than 20 percent and particularly preferred less than 5 percent of the maximum extension of the seismic mass perpendicular to the torsional axis and parallel to the main plane of extension. Consequently, an arrangement of the suspension region and the linking region is preferably assured on a comparatively small substrate area, so that the effects of bending of the substrate on the distance between the seismic mass and the electrode are comparatively slight. In an especially preferred manner, the linking region and the suspension region are situated comparatively close to the torsional axis, so that a completely symmetrical positioning of the sensor system is simplified especially advantageously, particularly if there is an integration of additional electrodes into the sensor system.

It is provided, according to another preferred refinement, that the linking region is situated perpendicular to the torsional axis and parallel to the main plane of extension in a region of the electrode facing the torsional axis, and/or that the area of the linking region parallel to the main plane of extension is smaller than the area of the electrode parallel to the main plane of extension. In one comparatively simple manner, the electrode is thus to be fastened as close as possible on the torsional axis using the linking region. The self-supporting region of the electrode projects from the linking region preferably perpendicular and/or parallel to the torsional axis, via a subsection of the seismic mass, so that, perpendicular to the main plane of extension, an overlapping is produced between one of the sides of the seismic mass separated by the torsional axis and the self-supporting regions of the electrode. Furthermore, because of a linking region that is as small in area as possible, the mechanical stress in the linking region is particularly advantageously reduced to a minimum in response to bending of the substrate.

It is provided, according to another preferred refinement, that the electrode is situated perpendicular to the main plane of extension between the seismic mass and the substrate, or that the seismic mass is situated perpendicular to the main plane of extension between the electrode and the substrate. Consequently, the measurement of a deflection of the seismic mass relative to the substrate is implemented particularly advantageously using electrodes below the seismic mass and/or using electrodes above the seismic mass. Electrodes situated above the seismic mass are especially implemented by an additional epitaxial layer, and they are deposited above the seismic mass during the production process of the sensor system.

According to one additional preferred refinement, it is provided that an electrode is situated, perpendicular to the main plane of extension, both above and below the seismic mass in each case. This has the advantage that the deflection of the seismic mass is measured both using electrodes above the seismic mass and using additional, particularly essentially identical electrodes below the seismic mass. Thus, in an advantageous manner, there is made possible a fully differential evaluation of the deflection movement on only one side of the torsional axis.

According to an additional preferred refinement, it is provided that the sensor system have an additional electrode which is identical to the above described electrode and which, particularly with respect to the torsional axis, is situated in mirror symmetry to the electrode, so that also a fully differential evaluation of a deflection of the seismic mass is advantageously made possible using electrodes on only one side of the seismic mass.

It is provided, according to another preferred refinement, that the linking region be situated along the torsional axis, generally centrically with respect to the seismic mass. Consequently, in a preferred manner, the influence of that type of bending of the substrate on the geometry of the sensor system is reduced that has an axis which is parallel to the main plane of extension and perpendicular to the torsional axis.

Exemplary embodiments of the present invention are shown in the figures and are explained in greater detail below.

### BRIEF DESCRIPTION OF THE DRAWINGS

FIG. 1 shows a schematic perspective view of a sensor system according to a first specific embodiment of the present invention.

FIG. 2 shows a schematic perspective view of a sensor system according to a second specific embodiment of the present invention.

FIG. 3 shows a schematic top view of a sensor system according to a third specific embodiment of the present invention.

FIG. 4 shows a schematic perspective view of a sensor system according to a fourth specific embodiment of the present invention.

FIGS. 5a and 5b show two schematic perspective views of a sensor system according to a fifth specific embodiment of the present invention.

FIG. 6 shows a schematic perspective view of a sensor system according to a sixth specific embodiment of the present invention.

FIG. 7 shows a schematic top view of a sensor system according to a seventh specific embodiment of the present invention.

FIG. 8 shows a schematic perspective view of a sensor system according to an eighth specific embodiment of the present invention.

FIG. 9 shows a schematic perspective view of a sensor system according to a ninth specific embodiment of the present invention.

### DETAILED DESCRIPTION OF EXAMPLE EMBODIMENTS

In the figures, identical parts are provided with the same reference numerals and thus are usually also named or mentioned only once.

FIG. 1 shows a schematic perspective view of a sensor system 1 according to a first specific embodiment of the present invention, sensor system 1 having a substrate 2, which is represented in an exaggeratedly bent manner to illustrate the mechanical stress with respect to its main plane of extension 100. In addition, sensor system 1 includes a seismic mass 3, which is fastened in a suspension region 5 on substrate 2 in such a way that seismic mass 3 is rotatable about a torsional axis 6 relative to substrate 2, suspension region 5 especially including a bending spring and/or a torsion spring. Seismic mass 3 has a mass element 10 on one side of torsional axis 6, which produces an asymmetrical mass distribution of seismic mass 3 with respect to torsional axis 6. The result is that, when there is an acceleration of sensor system 1 perpendicular to main plane of extension 100, a torque acts on seismic mass 3. A deflection of seismic mass 3 is evaluated capacitively using an electrode 4 and an additional electrode 4′, electrode and additional electrode 4′ being situated “above” seismic mass 3, that is, as seen perpendicular to main plane of extension 100, seismic mass 3 is situated between substrate 2 and electrode 4 and additional electrode 4′. Electrode 4 is developed as a self-supporting electrode, which is fastened to substrate 2 using a linking region 7. In order for the bending of substrate 2 to have as little as possible an influence on the geometry between seismic mass 3 and electrode 4, that is, particularly on the distance between seismic mass 3 and electrode 4 perpendicular to main plane of extension 100, linking region 7 is situated in the vicinity of suspension region 5. In this context, linking region 7 is situated in a region of electrode 4 facing torsional axis 6, so that the distance between torsional axis 6 and linking region 7, perpendicular to torsional axis 6 and parallel to main plane of extension 100, becomes minimal. The area of linking region 7 parallel to main plane of extension 100 is smaller by a multiple than the area of electrode 4. Additional electrode 4′ is developed essentially identical to electrode 4, additional electrode 4′ being developed in mirror symmetry to electrode 4 with respect to torsional axis 6, so that additional electrode 4′ is fastened on substrate 2, using an additional linking region 7′, which is also situated in the vicinity of suspension region 5. In particular, sensor system 1 includes an acceleration sensor that is sensitive in the z direction, i.e., perpendicular to main plane of extension 100, the sensor system preferably being provided to be packaged in a mold housing. In one alternative specific embodiment that is not shown, electrode 4 and additional electrode 4′ are situated between seismic mass 3 and substrate 2 or, in addition to electrode 4 and additional electrode 4′ according to the first specific embodiment, a further electrode 44 and a further additional electrode 44′ are situated between seismic mass 3 and substrate 2. In one further alternative specific embodiment, electrode 4 and additional electrode 4′ each have a plurality of linking regions 7 and a plurality of additional linking regions 7′. It is especially preferred if electrode 4 and additional electrode 4′ have exactly two linking regions 7 and exactly two additional linking regions 7′, which are situated parallel to torsional axis 6, in each case on both sides of seismic mass 3. Seismic mass 3 is especially preferably also fastened on substrate 2 using exactly two suspension regions 5, in each case one suspension region 5 being situated along torsional axis 6 on one of the two sides of seismic mass 3.

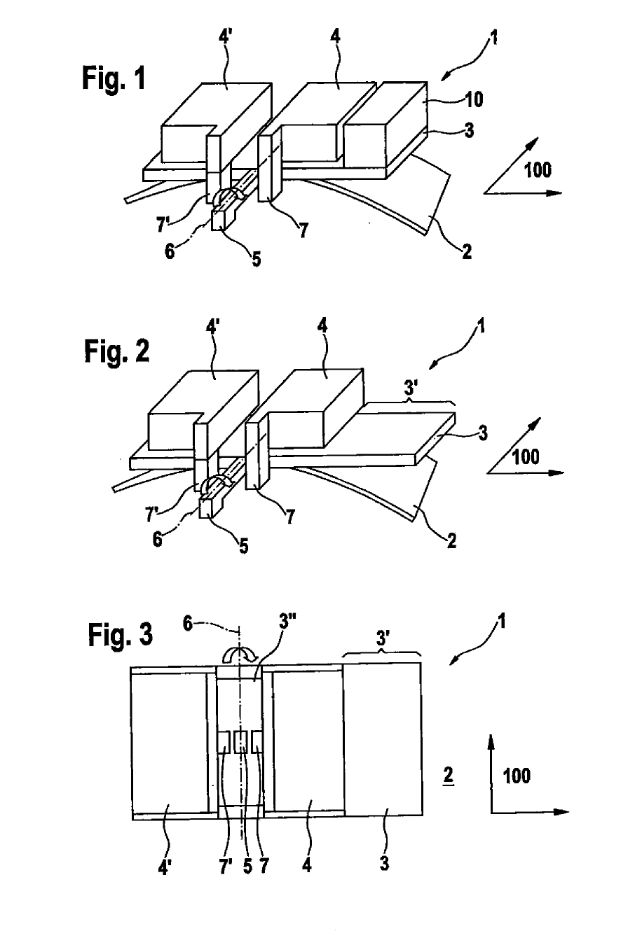

FIG. 2 shows a schematic perspective view of a sensor system 1 according to a second specific embodiment of the present invention, the second specific embodiment being generally identical to the first specific embodiment illustrated in FIG. 1; seismic mass 3 having no mass element 10 for producing the asymmetrical mass distribution with respect to torsional axis 6, but instead has an extension 3′ on one side of torsional axis 6. This extension 3′ of seismic mass 3 also ensures an asymmetrical mass distribution of seismic mass 3 with respect to torsional axis 6. Sensor system 1 according to the second specific embodiment has the advantage over sensor system 1 according to the first specific embodiment that seismic mass 3 is less sensitive to accelerations that act parallel to torsional axis 6, since in that case no torque is acting about an additional axis of rotation perpendicular to torsional axis 6.

FIG. 3 shows a schematic top view of a sensor system 1 according to a third specific embodiment of the present invention, the third specific embodiment being generally identical to the second specific embodiment illustrated in FIG. 2; seismic mass 3 having a central opening 3″ in the vicinity of torsional axis 6; and suspension region 5, linking region 7 and additional linking region 7′, being situated in central opening 3″ in such a way that suspension region 5, linking region 7 and additional linking region 7′ are situated parallel to torsional axis 6 in a centrical way with respect to seismic mass 3.

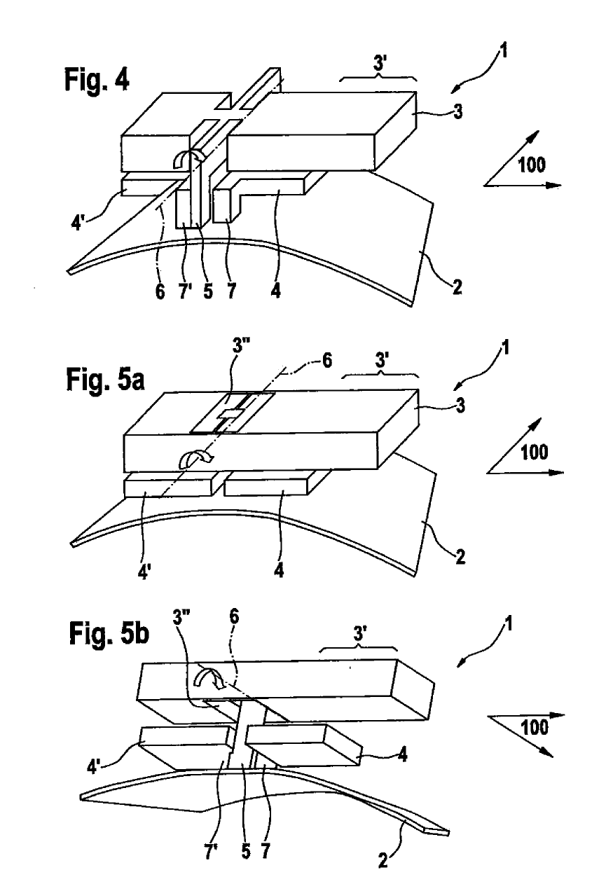

FIG. 4 shows a schematic perspective view of a sensor system 1 according to a fourth specific embodiment of the present invention, the fourth specific embodiment being generally identical to the second specific embodiment illustrated in FIG. 2, electrode 4 and additional electrode 4′ being situated between seismic mass 3 and substrate 2.

FIGS. 5a and 5b show two schematic perspective views of a sensor system 1 according to a fifth specific embodiment of the present invention, the fifth specific embodiment being generally identical to the third specific embodiment illustrated in FIG. 3, electrode 4 and additional electrode 4′ being situated between seismic mass 3 and substrate 2.

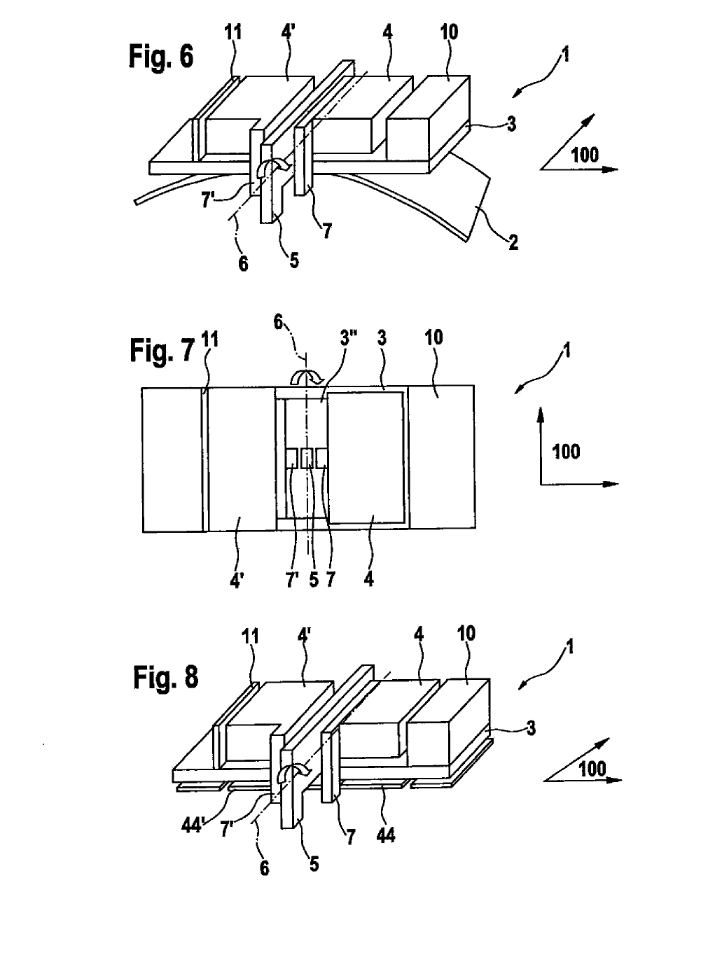

FIG. 6 shows a schematic perspective view of a sensor system 1 according to a sixth specific embodiment of the present invention, the sixth specific embodiment being generally identical to the first specific embodiment illustrated in FIG. 1; an area of seismic mass 3 facing substrate 2, i.e. the lower side of seismic mass 3, is symmetrically developed with respect to torsional axis 6, that is, both the area size and the geometry of the area are developed the same on both sides of torsional axis 6. In particular, because of this, the parasitic electrical capacitances are of the same magnitude on both sides of torsional axis 6. Surface charges which position themselves, for example, on the lower side of seismic mass 3 during the production process, and thus effect an electrostatic interaction between the lower side of seismic mass 3 and substrate 2, are thereby also situated symmetrically with respect to torsional axis 6, and therefore apply no effective torque to seismic mass 3. The lower side of seismic mass 3 shown in FIG. 1 is preferably also developed symmetrically with respect to torsional axis 6, in sensor system 1 according to the first specific embodiment. Furthermore, seismic mass 3 of the sixth specific embodiment has a compensation element 11, by contrast to the first specific embodiment, which is situated on one side of seismic mass 3, with respect to torsional axis 6, that is opposite to the side having mass element 10. On the side of seismic mass 3 having mass element 10, seismic mass 3 has a first interaction area which includes at least one first subsection of seismic mass 3 parallel to main plane of extension 100 and a second subsection of mass element 10 perpendicular to main plane of extension 100 and parallel to torsional axis 6, and which is assigned to electrode 4. In a position at rest of seismic mass 3, in order to achieve a symmetrical distribution of the electrostatic interaction forces with respect to torsional axis 6, besides the asymmetrical distribution, seismic mass 3 has compensation element 11. Compensation element 11 is constructed in such a way that, at least one third subsection of seismic mass 3 parallel to main plane of extension 100, and a fourth subsection of compensation element 11 perpendicular to main plane of extension 100 and parallel to torsional axis 6, form a second interaction area, which has generally the same geometry and the same area as the first interaction area. The first and the second interaction areas are thus symmetrical with respect to torsional axis 6.

FIG. 7 shows a schematic top view of a sensor system 1 according to a seventh specific embodiment of the present invention, the seventh specific embodiment being generally identical to the sixth specific embodiment illustrated in FIG. 6; seismic mass 3 having a central opening 3″ similar to that in FIG. 3; and suspension region 5, linking region 7 and additional linking region 7′ being situated in parallel to torsional axis 6 and centrically with respect to seismic mass 3, similar to those in FIG. 3.

FIG. 8 shows a schematic perspective view of a sensor system 1 according to an eighth specific embodiment of the present invention, the eighth specific embodiment being generally identical to the sixth specific embodiment illustrated in FIG. 6; between seismic mass 3 and substrate 2, a further electrode 44 and a further additional electrode 44′ being situated on substrate 2 for evaluating the deflection of seismic mass 3 relative to substrate 2. Torsional axis 6 runs between further electrode 44 and further additional electrode 44′, in this instance.

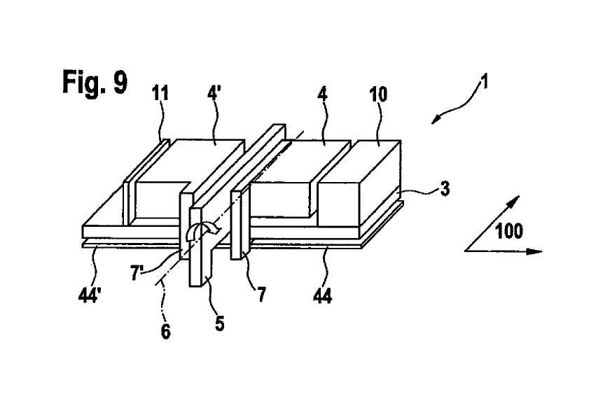

FIG. 9 shows a schematic perspective view of a sensor system 1 according to a ninth specific embodiment of the present invention, the ninth specific embodiment being generally identical to the eighth specific embodiment illustrated in FIG. 8; further electrode 44 overlapping generally the entire area of seismic mass 3 on the one side of torsional axis 6 perpendicular to main plane of extension 100; and further additional electrode 44′ overlapping generally the entire area of seismic mass 3 on the other side of torsional axis 6 perpendicular to main plane of extension 100.

What is claimed is:

1. A sensor system, comprising:
a substrate having a main plane of extension; and
a seismic mass which is movable about a torsional axis that is parallel to the main plane of extension, the seismic mass having an asymmetrical mass distribution with respect to the torsional axis, wherein an area of the seismic mass facing the substrate is symmetrical with respect to the torsional axis.

2. The sensor system as recited in claim 1, wherein the seismic mass, on a side facing away from the substrate, has at least one mass element for producing the asymmetrical mass distribution.

3. The sensor system as recited in claim 1, further comprising:
a compensation element situated on a side facing away from the substrate, the torsional axis being situated parallel to the main plane of extension between the mass element and the compensation element.

4. The sensor system as recited in claim 3, wherein the seismic mass has a first and a second interaction area, the first interaction area being assigned to a stationary electrode and the second interaction area being assigned to a stationary, additional electrode, a size of the first interaction area being equal to a size of the second interaction area, a geometric shape of the first interaction area being equal to a geometric shape of the second interaction area.

5. The sensor system as recited in claim 4, wherein the first and the second interaction areas are symmetrical with respect to the torsional axis, the first interaction area including areas of the side of the seismic mass facing away from the substrate and areas of the mass element, and the second interaction area includes additional areas of the side of the seismic mass facing away from the substrate and areas of the compensation element.

6. A sensor system comprising:
a substrate having a main plane of extension;
a seismic mass fastened on the substrate in a suspension region movably about a torsional axis that is parallel to the main plane of extension, the seismic mass having an asymmetrical mass distribution with respect to the torsional axis; and
at least one at least partially self-supporting electrode connected to the substrate in a linking region, the linking region being situated perpendicular to the torsional axis and parallel to the main plane of extension at least one of in the vicinity of the suspension region and directly adjacent to the suspension region.

7. The sensor system as recited in claim 6, wherein a distance between the suspension region and the linking region perpendicular to the torsional axis and parallel to the main plane of extension includes less than 50 percent of a maximum extension of the seismic mass perpendicular to the torsional axis and parallel to the main plane of extension.

8. The sensor system as recited in claim 6, wherein the distance is less than 20 percent of the maximum extension of the seismic mass perpendicular to the torsional axis and parallel to the main plane of extension.

9. The sensor system as recited in claim 6, wherein the distance is less than 5 percent of the maximum extension of the seismic mass perpendicular to the torsional axis and parallel to the main plane of extension.

10. The sensor system as recited in claim 6, wherein the linking region is situated perpendicular to the torsional axis and parallel to the main plane of extension in a vicinity of the electrode facing the torsional axis.

11. The sensor system as recited in claim 6, wherein an area of the linking region parallel to the main plane of extension is smaller than the area of the electrode parallel to the main plane of extension.

12. The sensor system as recited in claim 6, wherein the electrode is situated perpendicular to the main plane of extension between the seismic mass and the substrate.

13. The sensor system as recited in claim 6, wherein the substrate is situated perpendicular to the main plane of extension between the electrode and the substrate.

14. The sensor system as recited in claim 6, wherein respectively one electrode is situated perpendicular to the main plane of extension both above and below the seismic mass.

15. The sensor system as recited in claim 6, wherein the sensor system has an additional electrode which is identical to the at least one electrode, the additional electrode being arranged in mirror symmetry to the at least one electrode with respect to the torsional axis.

16. The sensor system as recited in claim 6, wherein the linking region is situated along the torsional axis centrically with respect to the seismic mass.
